(19) United States
(12) Patent Application Publication
(10) Pub. No.: US 2007/0290069 A1
(43) Pub. Date: Dec. 20, 2007

(54) HYDRAULIC RESERVOIR ARRANGEMENT

(76) Inventor: Richard A. Moen, Glenwood, MN (US)

Correspondence Address: CNH AMERICA LLC, INTELLECTUAL PROPERTY LAW DEPARTMENT, 700 STATE STREET, RACINE, WI, 53404, US

(21) Appl. No.: 11/424,691

(22) Filed: Jun. 16, 2006

(51) Int. Cl. B05B 9/00

(52) U.S. Cl. 239/124; 239/127

(57) ABSTRACT

A hydraulic reservoir arrangement supported on a self-propelled agricultural applicator is provided. The hydraulic reservoir arrangement includes a tank that is preassembled so as to define an enclosed cavity configured to receive a hydraulic fluid flow. The tank includes an opening at an uppermost surface. The arrangement further includes a return conduit that is generally linear and vertically aligned along its entire length. An angled fitting is connected at an uppermost end of the return conduit. The opposite lowermost end of the return conduit passes through the opening of the uppermost surface and extends into the cavity of the tank. Only a weld connection at an outer surface of the tank attaches the return conduit at the tank.

### CROSS-REFERENCE TO RELATED APPLICATIONS

Not applicable.

### BACKGROUND OF THE INVENTION

1. Field of Invention

The invention relates to a vehicular agricultural applicator and, more particularly, to a vehicular agricultural applicator having a hydraulic reservoir arrangement with fewer components and that reduces opportunities for leaks.

2. Related References

There are numerous types of self-propelled or vehicular agricultural applicators available today. Typical vehicular agricultural applicators include a chassis assembly supported on three or more tires. The chassis assembly is configured to support one or more bulk storage tanks or bins of product for application in an agricultural environment, usually before planting in the spring or after harvest in the fall. The types of agricultural products e.g., fertilizer, herbicide, pesticide, nutrients, etc. can vary. The vehicular agricultural applicator can also be utilized to tow various agricultural implements.

A conventional vehicular agricultural applicator includes a drive unit mounted toward a rearward end of the chassis assembly and rearward of a cab relative to a forward direction of travel. The drive unit typically includes a hydraulic drive system having a hydraulic reservoir configured to provide pressurized hydraulic flow to drive various hydraulic driven components (e.g., blower, towed folding implements, etc.) associated with operation of the agricultural applicator. The reservoir typically receives return conduits configured to convey return hydraulic fluid flow from the various hydraulic-driven components back to the reservoir tank.

There is a desire for a reservoir arrangement that requires fewer parts to manufacture and assemble. The reservoir arrangement should also be provide reliable sealing and be capable of withstanding the vibration associated with operation of the applicator in the field.

### SUMMARY OF THE INVENTION

The present invention provides a hydraulic reservoir arrangement supported on a vehicular agricultural applicator. The hydraulic reservoir arrangement includes a tank that is preassembled so as to define an enclosed cavity configured to receive a hydraulic fluid flow. The tank includes an opening at an uppermost surface. The arrangement further includes a return conduit that is generally linear and vertically aligned along its entire length. An angled fitting is connected at an uppermost end of the return conduit. The opposite lowermost end of the return conduit passes through the opening of the uppermost surface and extends into the cavity of the tank. Only a weld connection at an outer surface of the tank attaches the return conduit at the tank.

In a preferred embodiment, the angled fitting defines a passage therethrough having an inlet aligned generally perpendicular to an outlet. The outlet is in general vertical alignment with the return conduit. One embodiment of the angled fitting is welded at the uppermost end of the return conduit. Alternatively, the angled fitting is attached by a threaded connection at the uppermost end of the return conduit. The weld connection that attaches the return conduit at the external surface of the tank is located between a lowermost end and an uppermost end of the return conduit.

In another embodiment, the present invention provides a vehicular agricultural applicator that includes a drive unit configured to drive movement of a wheeled chassis assembly in a direction of travel, and a reservoir arrangement supported on the wheeled chassis assembly. The reservoir arrangement includes a tank that is preassembled so as to define an enclosed cavity configured to receive a hydraulic fluid flow. The tank includes an opening at an uppermost surface. The arrangement further includes a return conduit that is generally linear and vertically aligned along its entire length. The return conduit passes through the opening of the uppermost surface and extends into the cavity of the tank. Only a weld connection at an outer surface of the tank attaches the return conduit at the tank.

The present invention also provides a method of assembling a hydraulic reservoir arrangement in general accordance with the forgoing description.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 illustrates a detailed isometric view of the reservoir arrangement of the invention.

FIG. 2 illustrates a cross-section view along line 2-2 in FIG. 1.

FIG. 3 illustrates a cross-section view along line 3-3 in FIG. 1.

FIG. 4 illustrates a cross-section view along line 4-4 in FIG. 1.

FIG. 5 illustrates an isometric view of a conventional vehicular agricultural arrangement.

### DETAILED DESCRIPTION OF THE PREFERRED EMBODIMENTS

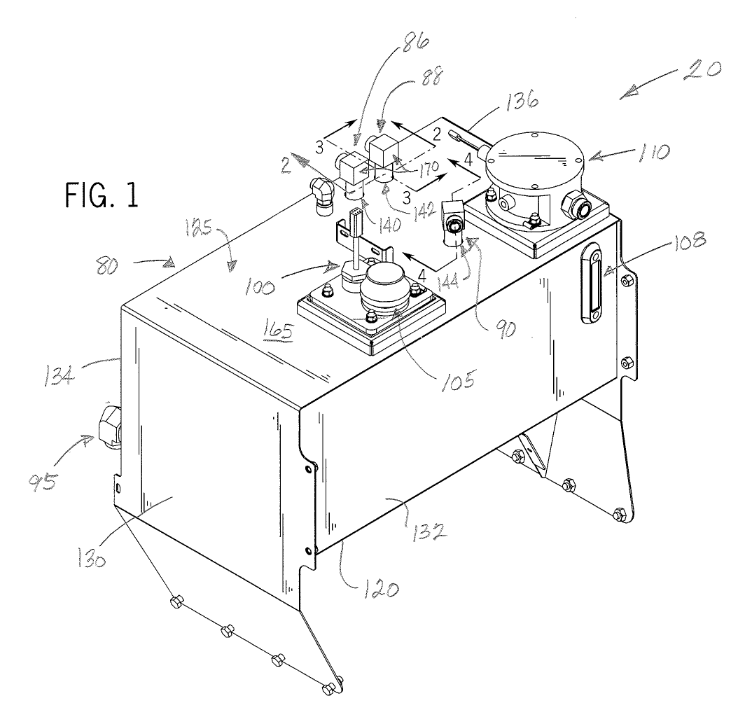

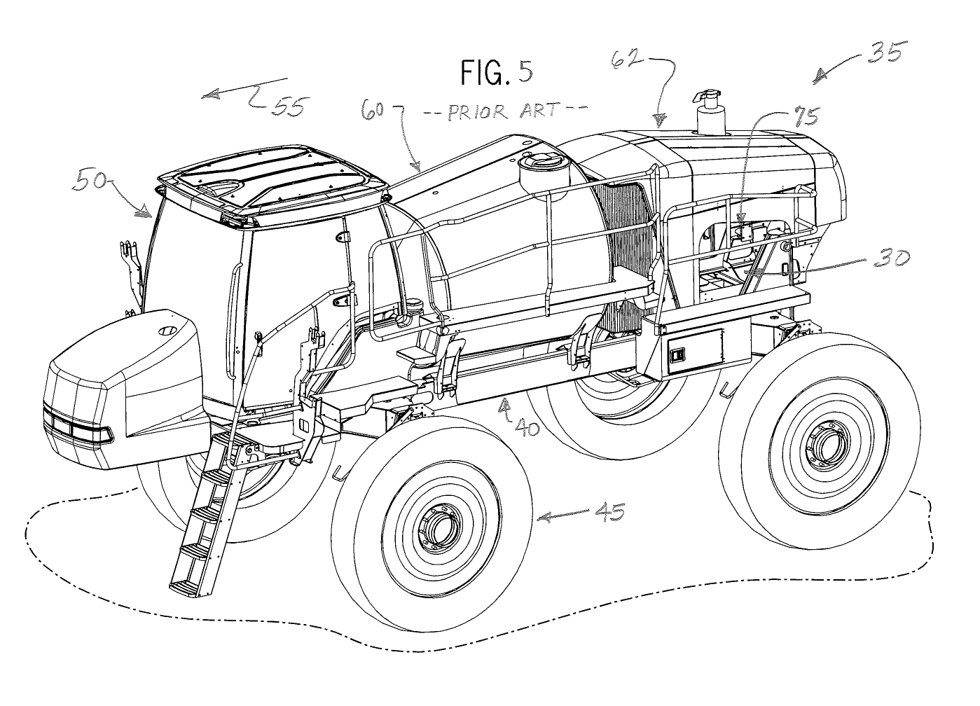

FIG. 1 illustrates an hydraulic reservoir arrangement 20 in accordance with the present invention mounted in use with a drive unit 30 of a vehicle 35 (See FIG. 5). Referring to FIG. 5, the exemplary vehicle 35 is an agricultural applicator having a wheeled frame assembly 40 configured to support the reservoir arrangement 20 and the drive unit 30 on a series of wheel assemblies 45. Although a four-wheeled vehicle 35 is shown, it is understood that the number of wheel assemblies 45 can vary. The vehicle 35 further includes a cab 50 supported on the wheeled frame assembly 40. The drive unit 30 is positioned rearward from the cab 50 relative to a forward direction of travel (illustrated by arrow 55) of the vehicle 35. A bulk storage tank 60 is also mounted on the wheeled frame assembly 40 so as to receive and carry product for distribution across a field. The exemplary bulk storage tank 60 is located between the drive unit 30 and the cab 50.

Still referring to FIG. 5, an enclosure assembly 62 encloses the conventional drive unit 30, which includes a radiator (not shown) disposed at a forward end of the drive unit 30, a hydraulic drive system, and an engine 75 disposed therebetween. In a known manner, the radiator operates to cool the engine 75. The hydraulic drive system generally provides hydraulic flow and pressure to various hydraulically-driven systems driven by the vehicle 35. The engine 75 is interconnected in a conventional manner to drive at least one of the wheel assemblies 45 and propel the wheeled frame assembly 40 in the forward direction of travel 55, so as to power the hydraulic drive system. Although a preferred drive unit 30 is described and shown, the type (e.g., diesel, etc.) and components (e.g., hydraulic system, pneumatic system, etc.) and combinations thereof comprising the drive unit 30 can vary and is not limiting on the invention.

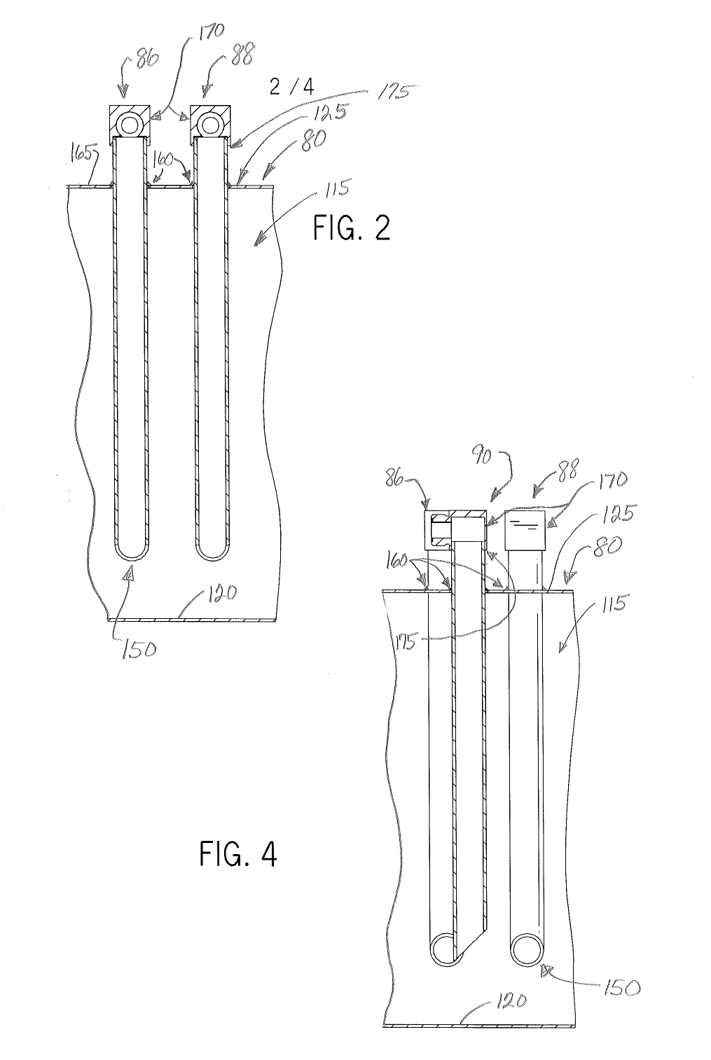

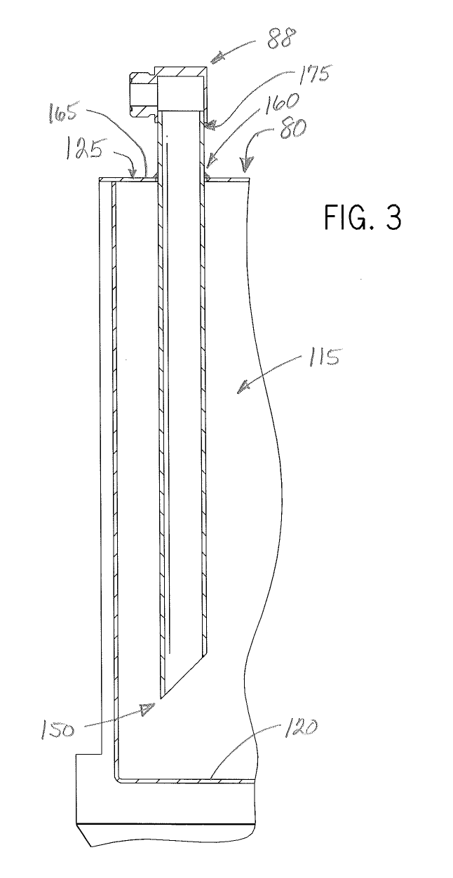

As illustrated in FIG. 2, the reservoir arrangement 20 of the invention is generally configured to receive return hydraulic fluid flow in association of operation of the hydraulic drive system powering the various hydraulic-driven components employed in association with the operation of the vehicular agricultural applicator (See FIG. 5). The exemplary reservoir arrangement 20 generally includes a tank 80, and at least one return conduit 86, 88 and 90 configured to convey the return hydraulic fluid flow to the tank 80. The exemplary reservoir arrangement 20 further includes at least one outlet port 95 configured to convey hydraulic fluid flow from the reservoir tank 80, a level indicator assembly 100, a vent 105, a sight level gauge 108, and a filter assembly 110 configured in a conventional manner to enhance operation of the hydraulic reservoir arrangement in combination with the hydraulic drive system.

The exemplary tank 80 is preassembled so as to define an enclosed cavity 115 therein configured to receive and store the hydraulic fluid flow. The tank 80 generally includes a lowermost floor 120 opposite an uppermost wall 125, and a series of sidewalls 130, 132, 134 and 136 extending upwardly in the generally vertical direction therebetween. The size and shape of the tank 80 can vary. The uppermost wall 125 includes a series of openings 140, 142 and 144 therethrough configured to receive return conduits 86, 88 and 90, respectively.

Each exemplary return conduit 86, 88 and 90 is generally linear and vertically aligned along its entire length. A lowermost end 150 of each return conduit 86, 88 and 90 passes through the respective opening 140, 142 and 144 of the uppermost wall 125 and extends into the cavity 115 of the tank 80. A weld connection 160 at an outer surface 165 of the uppermost wall 125 of the tank 80 attaches each return conduit 86, 88 and 90 at the tank 80.

The reservoir arrangement 20 further includes an angled fitting 170 connected at an uppermost end of each return conduit 86, 88 and 90. The angled fitting 170 is connected to each of the return conduits 86, 88 and 90 by a fixed connection 175 (e.g., weld, threaded, etc.).

It is understood that the above-description is of preferred exemplary embodiments of the reservoir arrangement 20 of the present invention. For example, while preferred embodiments of the reservoir arrangement 20 is generally described with reference to a four-wheeled vehicular agricultural applicator 35, it should be understood that the invention is in no way so limited. The hydraulic reservoir arrangement 20 can be configured for any type of drive unit of various types of vehicles 35, such as, construction vehicles, all-terrain (ATV) recreational vehicles, lawn-mowing tractors, etc. and is not limiting on the invention. Also, the hydraulic reservoir arrangement 20 is not limited for application on a vehicle 35 having the drive unit 30 located rearward of the cab 50. Further, the hydraulic reservoir arrangement 20 is not limited to being located between the drive unit 30 and the bulk storage tank 60 carried by the vehicle 35.

Many changes and modifications could be made to the invention without departing from the spirit thereof. The scope of these changes will become apparent from the appended claims.

We claim:

1. A reservoir arrangement for receiving a return flow of hydraulic fluid associated with operation of a vehicular agricultural applicator, comprising:
a tank that is preassembled to as to define an enclosed cavity configured to receive a fluid, the tank including an opening at an uppermost surface;
a return conduit that is generally linear and vertically aligned along its entire length, the return conduit passing through the opening of the uppermost surface and extending into the cavity of the tank,
wherein only a weld connection at an outer surface of the tank attaches the return conduit at the tank.

2. The reservoir arrangement as recited in claim 1, further comprising:
an angled fitting connected at an uppermost end of the return conduit, the angled fitting defining a passage therethrough having an inlet aligned generally perpendicular to an outlet.

3. The reservoir arrangement as recited in claim 2, wherein the angled fitting is welded at the uppermost end of the return conduit.

4. The reservoir arrangement as recited in claim 2, wherein the angled fitting is attached by a threaded connection at the uppermost end of the return conduit.

5. The reservoir arrangement as recited in claim 2, wherein the weld connection is located between a lowermost end and an uppermost end of the return conduit.

6. A vehicular agricultural applicator, comprising:
a drive unit configured to drive movement of a wheeled chassis assembly in a direction of travel; and
a reservoir arrangement supported on the wheeled chassis assembly, the reservoir arrangement comprising:
a tank that is preassembled to as to define an enclosed cavity configured to receive a hydraulic fluid flow, the tank including an opening at an uppermost surface;
a return conduit that is generally linear and vertically aligned along its entire length, the return conduit passing through the opening of the uppermost surface and extending into the cavity of the tank,
wherein only a weld connection at an outer surface of the tank attaches the return conduit at the tank.

7. The agricultural applicator as recited in claim 6, the reservoir arrangement further comprising:
an angled fitting connected at an uppermost end of the return conduit, the angled fitting defining a passage therethrough having an inlet aligned generally perpendicular to an outlet.

8. The agricultural applicator as recited in claim 7, wherein the angled fitting is welded at the uppermost end of the return conduit.

9. The agricultural applicator as recited in claim 7, wherein the angled fitting is attached by a threaded connection at the uppermost end of the return conduit.

10. A method of assembling a hydraulic reservoir arrangement in use with a drive unit of a vehicular agricultural applicator, the method comprising the steps of:
providing a tank that defines a cavity configured to receive a fluid, the tank including an opening at an uppermost surface;
connecting an angled fitting at one free end of a linear aligned return conduit;
inserting the second free end of the linear aligned return conduit through the opening at the uppermost surface of the tank and extending into the cavity such that the return conduit is generally vertically aligned; and
connecting the return conduit at the tank with only a weld connection at an exterior surface of the tank, wherein the weld connection is at the tank and at the return conduit,
wherein the angled fitting is configured to convey a fluid flow through the return conduit and into the tank.

11. The method as recited in claim 10, wherein the step of connecting an angled fitting includes threadly connecting the angled fitting at the one free end of the return conduit line before the step of inserting the return conduit.

12. The method as recited in claim 10, wherein the step of connecting an angled fitting includes welding the angled fitting at the one free end of the return conduit line before the step of inserting the return conduit.
